(19) United States
(12) Patent Application Publication
(10) Pub. No.: US 2026/0040155 A1
(43) Pub. Date: Feb. 5, 2026

(54) METHODS, ARCHITECTURES, APPARATUSES, AND SYSTEMS FOR INTER-RADIO ACCESS TECHNOLOGY BASED ON LOWER LAYER BASED MOBILITY

(71) Applicant: InterDigital Patent Holdings, Inc., Wilmington, DE (US)

(72) Inventors: Brian Martin, Farnham (GB); Martino Freda, Laval (CA); Dylan Watts, Montreal (CA); Oumer Teyeb, Montreal (CA); Paul Marinier, Brossard (CA); Keiichi Kubota, Tokyo (JP); Tao Deng, New York, NY (US)

(21) Appl. No.: 18/795,032

(22) Filed: Aug. 5, 2024

(51) Int. Cl. H04W 36/00; H04W 36/36

(52) U.S. Cl. CPC H04W 36/0058; H04W 36/0016; H04W 36/362

(57) ABSTRACT

Methods and systems are provided for inter-Radio Access Technology (RAT) mobility prioritization between two wireless networks, each having a RAT, such as 5G and 6G. The methods involve requesting information about each RAT and their respective networks, receiving an indication of a priority of one RAT relative to the other, and performing mobility procedures based on the priority. These procedures include measurement configurations, identifying candidate cells, and activating or deactivating mobility procedures. The system includes a wireless transmit and/or receive unit (WTRU) configured to request information, determine priorities, and perform mobility procedures. Mobility procedures are controlled between different wireless networks based on their conditions and priorities, thereby making efficient use of network resources and enabling seamless transitions between network technologies.

### TECHNICAL FIELD

The present disclosure is generally directed to the fields of communications, hardware, software, encoding, 5G System (5GS), and 6G System (6GS).

### BACKGROUND

The 3rd Generation Partnership Project (3GPP) introduced Layer 1/Layer 2 (L1/L2) Triggered Mobility (LTM) in Release 18 and planned enhancements for Release 19, which may form the basis for 6G mobility. LTM includes a Next Generation Node B (gNodeB) receiving L1 measurement reports from User Equipment (UE) and using them to change the UE's serving cell. This process may reduce mobility latency by allowing the UE to synchronize with multiple cells in advance for faster switching. However, the UE must follow orders for random access procedures, even if it can derive Timing Advance (TA) values itself, which leads to inefficiencies.

One LTM procedure includes eight steps, starting with the UE sending a MeasurementReport to a gNodeB, which then decides to configure LTM and initiates preparation. The gNodeB sends an RRCReconfiguration message to the UE with LTM candidate configurations, which the UE stores and confirms with an RRCReconfigurationComplete message. The UE then synchronizes with candidate cells and performs L1 measurements on them, reporting back to the gNodeB. The gNodeB decides on a target cell and triggers the switch via a Medium Access Control-Control Element (MACCE). The UE performs a Random Access Channel (RACH) procedure if it does not have a valid TA for the target cell, completes the switch, and confirms with an RRCReconfigurationComplete message.

For 6G migration, Multi-Radio Access Technology (RAT) Spectrum Sharing (MRSS) is theorized but not yet available or developed. One option being considered is a Dual Connectivity (DC) approach, similar to that of Evolved Universal Terrestrial Radio Access Network (E-UTRAN) New Radio-Dual Connectivity (EN-DC). However, this approach has problems, such as UEs having to camp and connect on 5G carriers, leading to lower data rates due to narrower carriers and higher load. Another option being considered is deploying 6G only as a standalone system, with MRSS for already deployed 5G bands. However, instantaneous setup of high data rates is not yet available or developed with this approach.

### SUMMARY

In certain representative embodiments, a method, performed via a first RAT of a first wireless network, for configuring inter-RAT mobility prioritization associated with the first RAT of the first wireless network and a second RAT of a second wireless network is provided. For example, the method includes receiving, via the second RAT, from the first wireless network, first information comprising a handover configuration and an indication of a priority of the second RAT. Also, for example, the method includes performing a first type of Radio Resource Management (RRM) measurement via the first RAT. Further, for example, the method includes, based on the priority, performing a second type of RRM measurement via the second RAT. In addition, for example, the method includes, if the second type of RRM measurement satisfies a condition, updating the first and second types of RRM measurements to third and fourth types of RRM measurements, respectively, and initiating a handover procedure to the second wireless network. Moreover, for example, the priority is determined at the first wireless network. Furthermore, for example, the indication of the priority includes all 6G carriers, standalone 6G carriers, or a combination of carriers. Additionally, for example, the handover configuration includes a first mobility procedure using the first type of RRM measurement associated with the first RAT and a second mobility procedure using a second type of RRM measurement associated with the second RAT. Still further, for example, the condition for determining how to perform the second type of RRM measurement includes comparing a standalone 6G carrier measurement to a threshold. Even further, for example, the first and second information includes the quality of each network, compared to predetermined thresholds. Yet further, for example, the method includes reducing a frequency of the first type of RRM measurement based on the priority. For example, the method includes cancelling the first mobility procedure. Also, for example, the method includes increasing the second type of RRM measurement, which includes increasing a frequency of the second type of RRM measurement, initiating measurement of an additional carrier, or initiating measurement of an additional beam. Further, for example, the method includes initiating the second mobility procedure, which includes inter-RAT lower layer triggered mobility (LTM) or inter-RAT synchronization. In addition, for example, the method includes performing a measurement report based on detecting 6G standalone coverage and determining the second wireless network is ready for handover. Moreover, for example, the method includes receiving, via the second RAT, from the first wireless network, first information comprising the handover configuration comprising information for one or more lower layer triggered mobility (LTM) candidates via the second RAT, performing one or more handover preparation steps using the second RAT while connected via the first RAT, receiving an LTM indication from the first wireless network to initiate reconfiguration to the second wireless network using the second RAT, performing a handover from the first wireless network to the second wireless network, and transmitting a handover complete indication to the second wireless network using the handover configuration received from the first wireless network.

In certain representative embodiments, a method is provided, performed by a wireless transmit and/or receive unit (WTRU), for configuring inter-Radio Access Technology (RAT) mobility prioritization between two wireless networks, each with a RAT. For example, the method includes measuring information about conditions associated with each RAT and their respective wireless networks. Also, for example, the method includes receiving, via the first RAT, an indication of a priority of the first RAT relative to the second RAT based on the requested information. Further, for example, the method includes performing mobility procedures associated with each RAT based on the priority. In addition, for example, the method includes determining the priority at the first wireless network. Moreover, for example, the mobility procedures include applying a measurement configuration associated with the first RAT. Furthermore, for example, the first wireless network is a 5G network, and the second is a 6G network. Additionally, for example, the information requested includes a quality of each network, compared to predetermined thresholds. Still further, for example, the mobility procedures include identifying candidate cells to measure or determining the periodicity of measurements. Even further, for example, the method includes activating or deactivating mobility procedures associated with the second RAT. Yet further, for example, the mobility procedures are associated with lower layer triggered mobility (LTM) or a conditional handover (CHO). For example, the method includes reducing a frequency of power saving inter-RAT measurements via the second RAT. Also, for example, the method includes cancelling any ongoing mobility procedure associated with the first RAT and initiating higher priority mobility towards the second wireless network via the second RAT when a measurement of a serving cell of the second wireless network is above a threshold for enabling measurements.

In certain representative embodiments, a WTRU is configured for inter-Radio Access Technology (RAT) mobility prioritization between two wireless networks, each associated with a RAT. For example, the WTRU includes a processor and a transceiver coupled to the processor. Also, for example, the WTRU is configured to measure first information via the first RAT, at the first wireless network, about conditions associated with the first RAT or the first wireless network serving the first RAT. Further, for example, the WTRU is configured to measure second information via the second RAT, at the second wireless network, about conditions associated with the second RAT or the second wireless network serving the second RAT. In addition, for example, the WTRU is configured to receive, via the first RAT, from the first wireless network, an indication of a priority of the first RAT relative to the second RAT based on the first and second information. Moreover, for example, the WTRU is configured to perform at least one first mobility procedure associated with the first RAT based on the priority of the first RAT being greater than the priority of the second RAT. Furthermore, for example, the WTRU is configured to perform at least one second mobility procedure associated with the second RAT based on the priority of the second RAT being greater than the priority of the first RAT. Additionally, for example, the WTRU is configured to control mobility procedures between two different wireless networks based on the conditions and priorities of the networks. Still further, for example, the WTRU is configured to make efficient use of network resources and seamless transitions between network technologies.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a sequence diagram illustrating an example of an LTM procedure;

FIG. 3 is a chart illustrating an example of MRSS;

FIG. 4 is a diagram illustrating an example of DC;

FIG. 5 is a diagram illustrating an example of 6G only as a standalone system;

FIG. 6 is a procedural diagram illustrating an example procedure for inter-RAT LTM;

FIG. 7 is a procedural diagram illustrating an example procedure, performed by a WTRU, for configuring inter-RAT mobility prioritization associated with a first RAT of a first wireless network and a second RAT of a second wireless network; and

FIG. 8 is a procedural diagram illustrating an example procedure for configuring inter-RAT mobility prioritization associated with a first RAT of a first wireless network and a second RAT of a second wireless network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

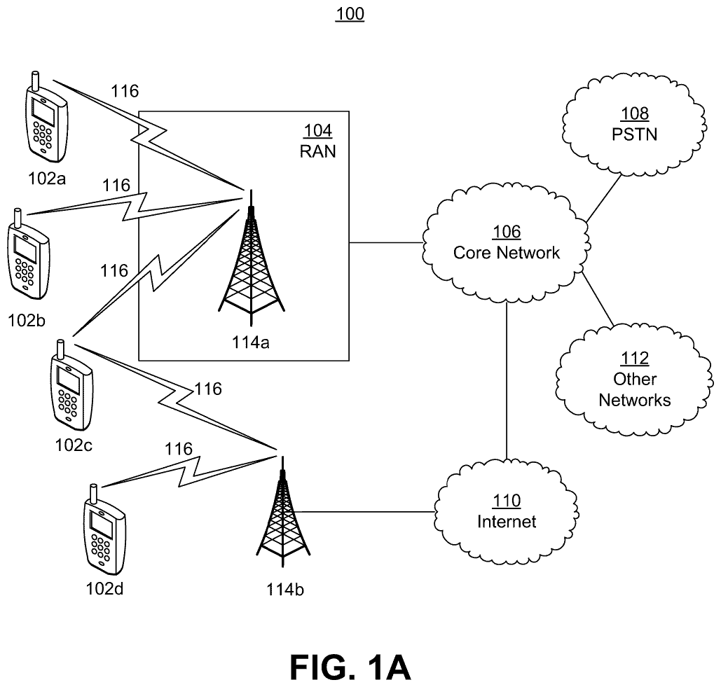

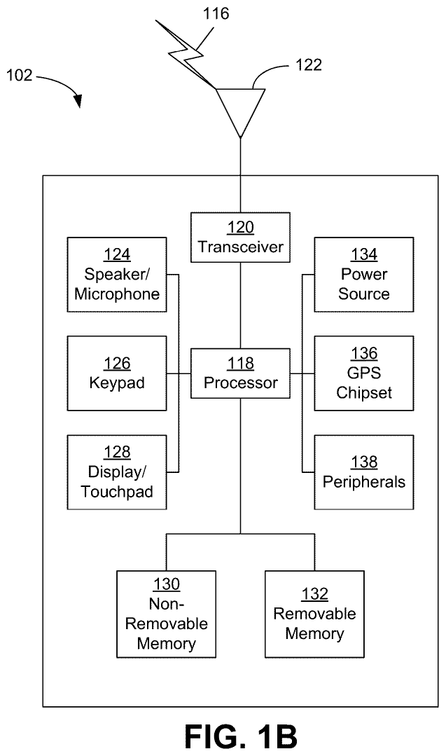

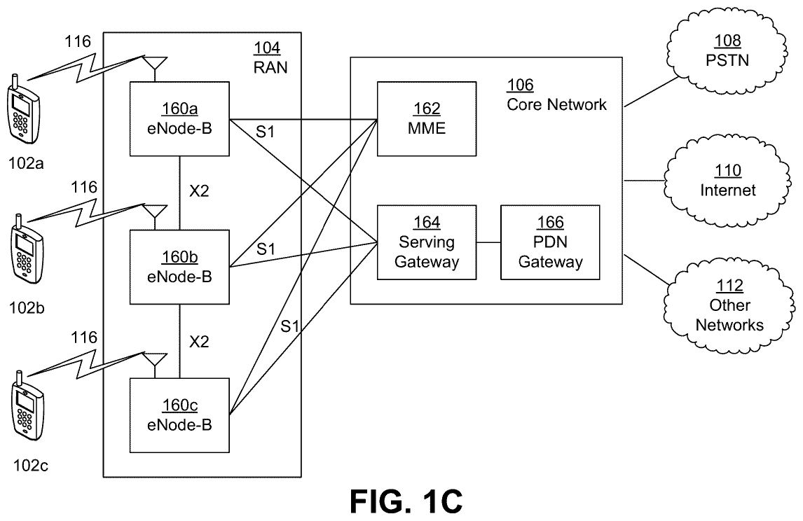

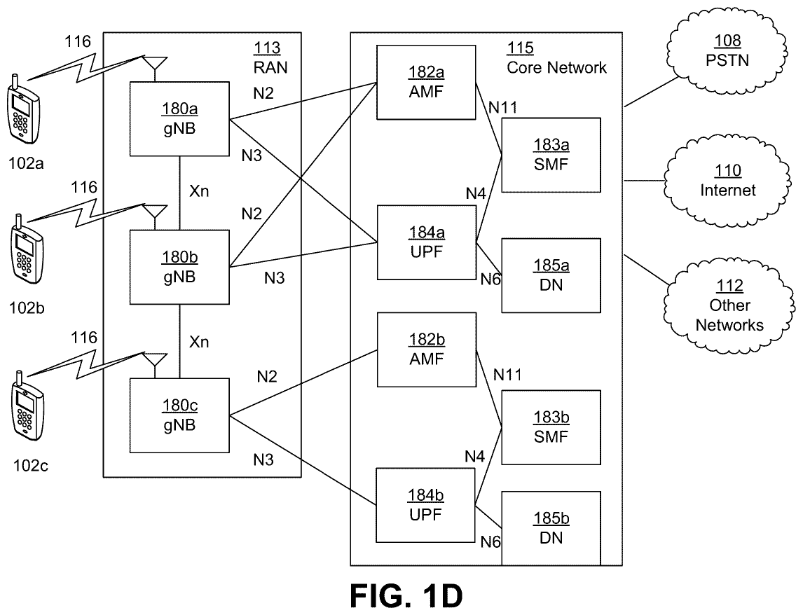

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (CNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example in in 802.11 systems. For CSMA/CA, the STAs (e.g., every STA), including the AP, may sense the primary channel. If, for example, the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and a transmitting STA may transmit the data. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if, for example, the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If, for example, the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

3GPP introduced Physical Layer or Layer 1 (L1)/Data Link layer or Layer 2 (L2) (L1/L2) Triggered Mobility (LTM) in Rel-18 and agreed to a work item for enhancement in Rel-19. It is expected that 6G mobility will use LTM procedures introduced to New Radio (NR) as a baseline.

3GPP TS 38.300 v18.1.0 section 9.2.3.5 describes existing LTM. An LTM procedure includes a Next Generation Node B (gNodeB or gNB) receiving L1 measurement reports from User Equipment (UE) and using them to change the UE's serving cell via a cell switch command. This command is signaled through a Medium Access Control (MAC) Control Element (CE) (MACCE) and indicates a pre-configured LTM candidate setup. The UE then switches to the target configuration as per the command, aiming to reduce mobility latency. In summary, the network can activate Transmission Configuration Indicator (TCI) states of multiple cells in advance, allowing the UE to synchronize with these cells for faster switching. The network can initiate early Timing Advance (TA) acquisition for candidate cells, enabling quicker cell switches. This can be done via Physical Downlink Control Channel (PDCCH) orders or UE-based TA measurements. Depending on the availability of a valid TA value, the UE performs either Random Access Channel (RACH)-less (without random access) or RACH-based (with random access) cell switches. The UE follows PDCCH orders for random access procedures, even if it can derive TA values itself. For RACH-less LTM, the UE uses either a configured grant or a dynamic grant to access the target cell and monitors PDCCH for dynamic scheduling.

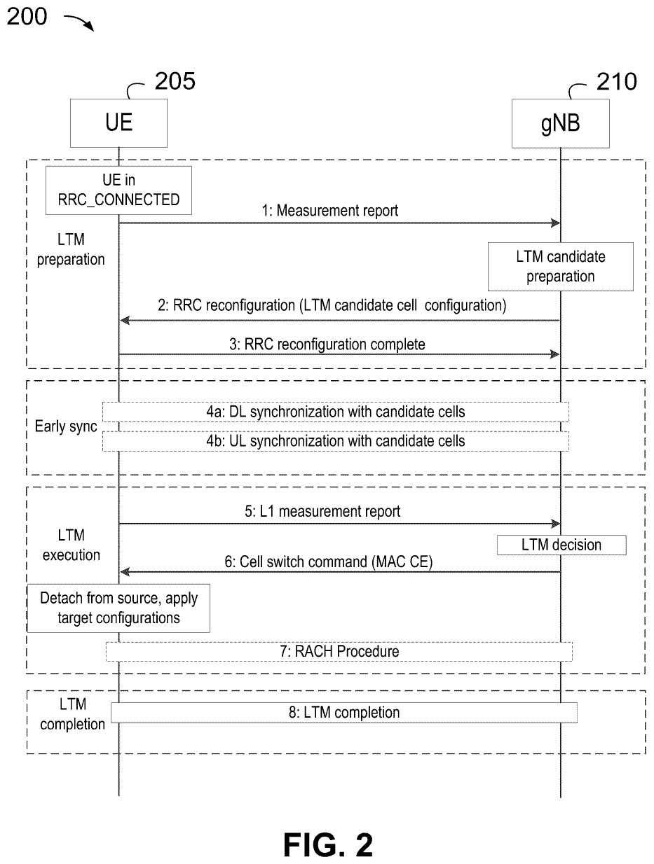

As shown in FIG. 2, a Rel-18 LTM procedure 200 includes eight steps. Step 1: A UE 205 sends a MeasurementReport to a node (gNB) 210 (e.g., providing NR user plane and control plane protocol terminations towards the UE 205, and connected via the NG interface to a 5G Core Network (5GC)), which then decides to configure LTM and initiates preparation. Step 2: The gNB 210 sends an RRCReconfiguration message to the UE 205 with LTM candidate configurations. Step 3: The UE 205 stores these configurations and confirms with an RRCReconfigurationComplete message. Step 4: The UE 205 synchronizes with candidate cells (downlink (DL) at Step 4a, and uplink (UL) at Step 4b) and, if configured, measures TA values. Step 5: The UE 205 performs L1 measurements on candidate cells and reports to the gNB 210. Step 6: The gNB 210 decides on a target cell and triggers the switch via MAC CE. Step 7: The UE 205 performs RACH procedure if it does not have a valid TA for the target cell. Step 8: The UE 205 completes the switch and confirms with an RRCReconfigurationComplete message.

Steps 4-8 can be repeated for subsequent LTM using the provided configurations. The procedure 200 applies to both intra-gNB Distributed Unit (DU) and intra-gNB-DU LTM, with overall procedures detailed in TS 38.401.

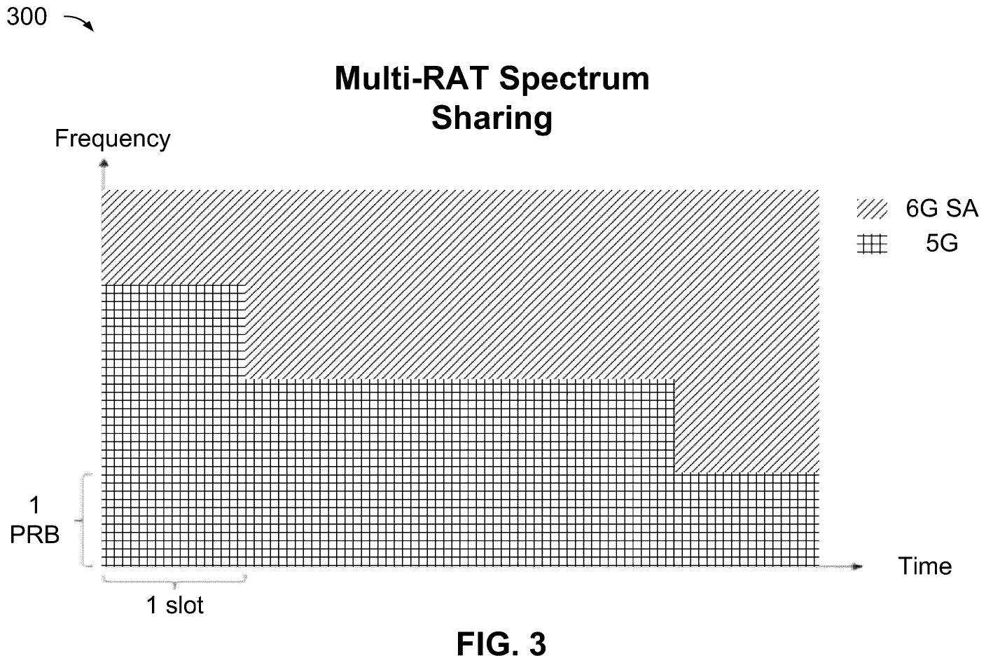

In addition, as shown in FIG. 3, for 6G migration, Multi-RAT Spectrum Sharing (MRSS) is theorized but not yet available or developed.

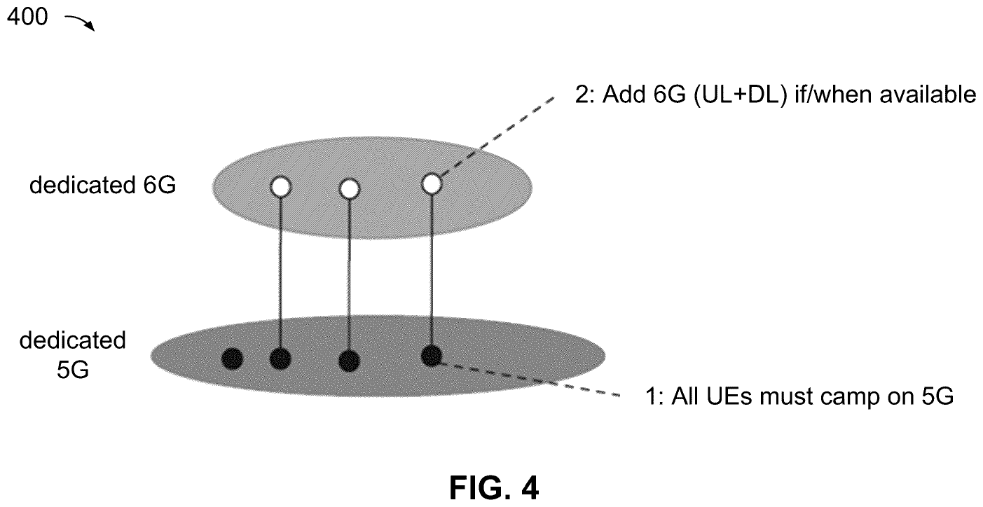

One option being considered is a Dual Connectivity (DC) approach, similar to that of Evolved Universal Terrestrial Radio Access Network (E-UTRAN) New Radio-Dual Connectivity (EN-DC) (e.g., UE connected to Long Term Evolution (LTE) as a primary cell group, and NR as a secondary cell group), as shown in FIG. 4. However, there are problems with this proposed approach, e.g., UEs must camp and connect on 5G carriers, which leads to lower data rates due to narrower carriers and higher load (higher load, because 5G and 6G UEs will be camped and connected in 5G). Also, additional 6G spectrum can be added only after connection setup, and used with a slow aggregation scheme (e.g., DC), which may benefit only relatively large file transfers.

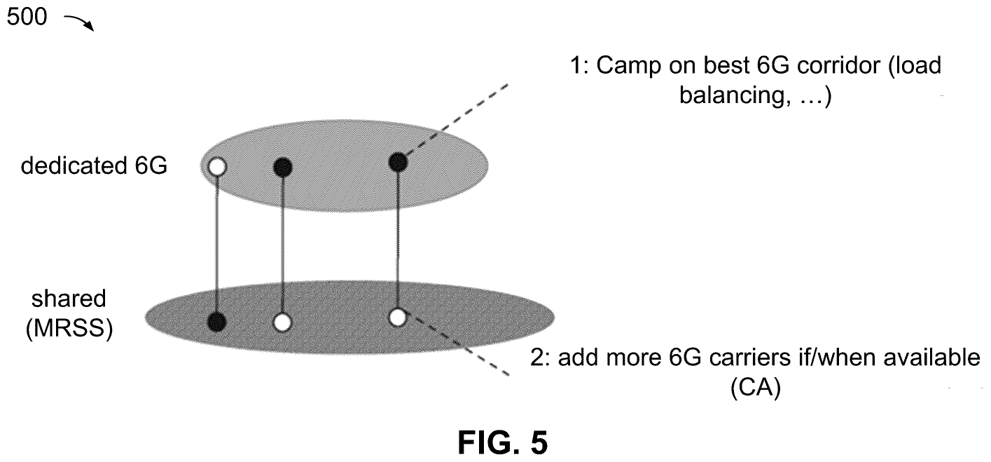

Another option being considered is deployment of 6G only as a standalone system, with MRSS for already deployed 5G bands, as shown in FIG. 5. With this approach, load balancing can ensure that UEs camp and connect on a given carrier, for example, on a wide centimeter-band carrier if in coverage. However, in this context, instantaneous setup of high data rates is not yet available or developed.

To help address the limitations and problems of these and other approaches, inter-RAT mobility is provided, e.g., on LTM. For example, mobility towards 6G standalone is prioritized without frequent measurements. Also, for example, 6G users achieve low load on 6G carriers so that distribution of traffic across spectrum assets is optimized. Further, for example, operators are provided with use of existing spectrum to deploy 6G, which effectively migrates the spectrum from 5G to 6G.

In certain representative embodiments, in wireless communications, LTM is provided with inter-RAT LTM. For example, inter-RAT LTM provides seamless connectivity in heterogeneous networks. Also, for example, advanced mobility support is provided to accommodate high-speed and/or low-latency requirements of 6G. Further, for example, inter-RAT is applied to LTM in order optimize handovers and/or load balance between different RATs. In addition, for example, accuracy and/or reliability of inter-RAT measurements are provided, thus providing overall performance of mobility procedures.

In certain representative embodiments, one or more measurement configurations arc utilized for one or more mobility procedures (e.g., LTM, conditional handover (CHO), or the like) and/or one or more RATs. For example, the one or more measurement configurations are based on a WTRU detecting one or more conditions on a source RAT and/or a target RAT. Also, for example, the WTRU applies a measurement configuration associated to a mobility procedure (e.g., candidate cells to measure, periodicity of measurements, or the like) on a first RAT based on conditions detected on a first RAT and/or a second RAT. Further, for example, based on detecting 5G NR quality below a threshold and 6G quality above a threshold, the WTRU applies a configuration with an increase of measurements on 6G. In addition, for example, the WTRU activates and/or deactivates a mobility procedure (e.g., LTM, CHO, or the like) towards the second RAT based on conditions detected on a first and/or second RAT.

In certain representative embodiments, one or more procedures are provided to enable LTM based handover from one RAT to another RAT. For example, the one or more procedures include at least one of pre-configuration of one or more inter-RAT candidate cells, lower-layer triggered handover between RATs, inter-RAT early synchronization, RACH-less handover between RATs, combinations of the same, or the like.

In certain representative embodiments, inter-RAT mobility is provided. When a new RAT is defined, it usually includes in a first specification release methods and procedures to support mobility between a new system and an existing system. This is because early deployments of a new specification release are often made in locations already covered by legacy systems, and the legacy systems usually provide better coverage, at least at the beginning, due to already deployed equipment. For example, the very first release of LTE included support for idle mode and connected mode mobility between UMTS and LTE, and GERAN and LTE. For idle mode, a new concept known as absolute priority-based cell reselection was introduced for LTE. UMTS and GERAN systems were updated to support the same type of mobility, primarily to support interworking with LTE. For connected mode, handover between UMTS and LTE, and between GERAN and LTE was introduced, which included performing inter-RAT measurements, and performing inter-RAT handover by providing the configuration in a handover command (e.g., an RRC reconfiguration, or the like) to initiate the inter-RAT change while in connected mode.

The very first release of 5G NR only supported NR as a secondary cell (e.g., E-UTRA-NR Dual Connectivity, or EN-DC, or the like). When standalone NR was introduced, similarly, idle mode and connected mode mobility between LTE and NR were introduced (e.g., absolute priority-based cell reselection, inter-RAT measurements, handover, or the like). LTM was introduced for NR in Release 18 (e.g., 5G advanced) and is being further enhanced in Release 19. It is anticipated that 6G NR will support a connected mode mobility procedure based on LTM from the first release. Support for inter-RAT LTM at least from 5G NR to 6G NR was, prior to the present disclosure, not developed.

In addition, based on the 6G migration discussions so far, most companies have indicated that MRSS should be used (e.g., even if a 5G-6G DC solution is additionally used, or the like) to allow for reuse of existing spectrum. Especially for the case of 6G standalone with MRSS, 6G-capable WTRUs should prioritize camping on a standalone 6G carrier to benefit from the lower load and higher throughput on offer. However, challenges remain. These and other challenges are addressed herein.

In certain representative embodiments, inter-RAT mobility is enabled based on LTM. For example, mobility is prioritized towards a 6G standalone carrier without requiring frequent measurements. Also, for example, frequent measurements such as high power consumption for the device, or the like, are reduced.

In certain representative embodiments, one or more measurement configurations arc utilized for one or more mobility procedures (e.g., LTM, conditional handover (CHO), or the like) and/or one or more RATs. For example, the one or more measurement configurations are based on a WTRU detecting one or more conditions on a source RAT and/or a target RAT. Also, for example, the WTRU applies a measurement configuration associated to a mobility procedure (e.g., candidate cells to measure, periodicity of measurements, or the like) on a first RAT based on conditions detected on a first RAT and/or a second RAT. Further, for example, based on a condition that 5G NR quality is below a threshold and 6G quality is above a threshold, a WTRU applies a configuration with relatively more measurements on 6G. In addition, for example, a WTRU activates and/or deactivates a mobility procedure (e.g., LTM, CHO, or the like) towards the second RAT based on conditions detected on a first RAT and/or a second RAT. Moreover, for example, a WTRU configured with LTM and/or CHO within cells of a first RAT (e.g., 5G, LTE, or the like) or a first carrier type (e.g., 5G/LTE and 6G carriers in MRSS carrier, or the like) is configured to perform relatively higher priority measurements of a second RAT (e.g., standalone 6G carriers, or the like). Furthermore, for example, a WTRU may perform relatively infrequent and/or power saving inter-RAT measurements on a higher priority RAT even if a serving cell measurement is above a threshold for enabling measurements. Additionally, for example, when a condition is met (e.g., WTRU detects the higher priority RAT above a threshold, or the like), a WTRU cancels any ongoing mobility procedure within a first RAT (e.g., reduce measurements, cancel CHO evaluation, or the like) and initiates higher priority mobility towards a second RAT (e.g., initiates more intense measurements, trigger inter-RAT handover based on independent threshold for handover, which may trigger inter-RAT handover even if the current cell quality is good, or the like).

In certain representative embodiments, a process (e.g., for enabling inter-RAT mobility based on LTM) includes at least one of a handover configuration, a priority indication, one or more mobility procedures, one or more RRM measurements, updates of one or more RRM measurements, one or more conditions for measurement, changes in a type and/or frequency of one or more measurements, transmitting indications related to the same, combinations of the same, or the like.

For example, a first step of the process includes a handover configuration. Also, for example, the first step includes receiving and/or storing a handover configuration for one or more candidates on a second RAT from a first RAT. Further, for example, the handover configuration includes an indication of whether a carrier on the second RAT is prioritized. In addition, for example, a priority indication includes at least one of all 6G carriers, only standalone 6G carriers, specific carriers, a combination of the same, or the like. Moreover, for example, a handover configuration includes a first mobility procedure using a first type of RRM measurement for use on a first RAT. Furthermore, for example, a handover configuration includes a second mobility procedure using a second type of RRM measurement for use on a second RAT (e.g., indicated as priority, or the like). Additionally, for example, a handover configuration includes a condition for determining how to perform a second type of RRM measurement.

For example, a second step of the process includes performing a first type of RRM measurement within cells and/or carriers of a first RAT. Even further, for example, the cells and/or the carriers of the first RAT include at least one of LTM, CHO, or the like amongst 5G carriers. Yet further, the first type of RRM measurements are based on one or more mobility requirements (e.g., measure when S-measure of the serving cell criteria is met).

For example, a third step of the process includes performing a second type of RRM measurement on carriers of a second RAT while performing a first type of RRM measurement on a first RAT, based on a priority indication. Also, for example, a less frequent and/or power-hungry monitoring for standalone 6G is performed, even if an S-measure of serving cell criteria is not met. Further, for example, prioritization of a connection to a standalone 6G is provided while limiting power consumption and/or measurements. In addition, for example, the second type of RRM measurement is only for prioritized carriers, e.g., lower priority (e.g., 6G MRSS) carriers use a first type of RRM measurement.

For example, a fourth step of the process includes, based on a second type of RRM measurement on a second RAT meeting a condition, updating a first type of RRM measurement and the second type of RRM measurement to a third type of RRM measurement and a fourth type of RRM measurement, respectively. Also, for example, the condition is a standalone 6G carrier measurement being above a threshold. Further, for example, the condition is based on a first RAT, and/or on both the first RAT and the second RAT (e.g., 5G NR quality below a threshold and 6G quality above a threshold, or the like). In addition, for example, a frequency of the first type of RRM measurement is reduced (e.g., stop measuring some of the 5G or MRSS carriers or resources based on a priority or a hierarchy, or the like). Moreover, for example, a first mobility procedure is cancelled (e.g., ongoing CHO evaluation, LTM reporting, or the like). Furthermore, for example, the second type of RRM measurement is increased (e.g., more frequent RRM measurements, or start measuring additional carriers and/or beams, or the like). Additionally, for example, a second mobility procedure is initiated (e.g., inter-RAT LTM, synchronization, or the like).

For example, a fifth step of the process includes transmitting an indication to a serving cell that a condition was met based on a second type of RRM measurement and initiating a handover procedure to a second RAT. Also, for example, the fifth step includes using LTM. Further, for example, the fifth step includes using a second threshold for performing a measurement report. In addition, for example, a first trigger is a detection of 6G standalone coverage, and the second threshold is monitored to determine if a second wireless network (e.g., including the second RAT) is suitable and/or ready for a handover.

In certain representative embodiments, monitoring and/or detection of prioritized connection to standalone 6G carriers are provided without having to configure frequent measurements. For example, power savings are achieved while allowing performance of detection of a new RAT, or the like. Also, for example, a handover occurs without waiting for current cell coverage to decline. Further, for example, measurements are enabled during the handover without waiting for the current cell coverage to decline. In addition, for example, inter-RAT mobility based on LTM is provided with a trade-off between complexity and/or latency and energy consumption. Moreover, for example, a WTRU and/or a network are provided with one or more inter-RAT measurements adapted to one or more conditions. Furthermore, for example, a WTRU and/or a network are provided with one or more mobility procedures adapted to one or more conditions.

In certain representative embodiments, one or more processes include at least one of performing one or more mobility procedures, identifying and/or utilizing one or more candidate cell sets, identifying and/or utilizing one or more Synchronization Signal Blocks (SSBs), identifying and/or utilizing one or more Channel State Information Reference Signals (CSI-RSs), identifying and/or utilizing CSI, identifying and/or utilizing one or more channel conditions, combinations of the same, or the like.

For example, “perform mobility procedure,” “perform mobility,” or the like refers to performing any and/or all of one or more steps shown, for example, in FIG. 3 for NR, or similar procedures for 6G. Also, for example, “perform mobility procedure,” “perform mobility,” or the like includes at least one of early synchronization in DL and/or UL to one or more of the candidate cells, performing L1 measurements, reporting on one or more of the candidate cells, switching (e.g., performing handover, or the like) between candidate cells, combinations of the same, or the like. Further, for example, “perform LTM” includes a WTRU moving and/or switching between candidate cells during a procedure, or the like.

For example, one or more candidate cell sets include groups of more than one RRC configuration corresponding to a handover configuration for one or more candidate SpCells and optionally SCells. Also, for example, the handover configuration is modelled and/or received as at least one of one or more complete RRC Reconfiguration messages, one or more cell group configurations, one or more cell configurations, combinations of the same, or the like. Further, for example, each of the candidate cell configurations includes a candidate configuration identifier, and each of the candidate cell groups includes a candidate cell group identifier. In addition, for example, if a grouping is performed at RRC, switching between different sets of candidate cells includes updating serving cell indexes or candidate configuration indexes, which are used in L1 and MAC signaling to refer to specific indexes (e.g., a MAC CE triggering the reconfiguration includes a candidate configuration index informing the WTRU of which cell to perform the reconfiguration to, or the like). Moreover, for example, one or more candidate cell groups are configured as a single list or groups of candidate cell configurations at RRC. Furthermore, for example, a grouping occurs at an early synchronization or LTM execution phase rather than at a configuration phase (e.g., the candidate cell set is considered as a single group in terms of an RRC configuration list or group, while cells selected for performing early synchronization, L1 measurements, and LTM execution depend on a further grouping into multiple subsets of the overall candidate cell list). Additionally, for example, a grouping itself is not modelled at RRC using candidate configuration identifiers, but the grouping is executed as part of early synchronization or an LTM execution procedure. Still further, for example, an LTM candidate configuration, or the like, applies to any type of preconfigured cell information. Even further, for example, a WTRU is configured with one or more conditional reconfigurations such as CHO, conditional PSCell addition (CPA), conditional PSCell change (CPC), or the like, which are valid before and/or after a cell change, and/or are valid in certain cells.

For example, an SSB and/or SS/Physical Broadcast Channel (PBCH) block, includes at least one of the following: Primary Synchronization Signal (PSS), Secondary Synchronization Signal (SSS), PBCH (Data, MIB), PBCH (DMRS), combinations of the same, or the like. Also, for example, the SSBs are transmitted by a network (NW) node (e.g., base station, transmission reception point (TRP), relay node, Reconfigurable Intelligent Surface (RIS) unit, or the like) in different directions (e.g., beams). Further, for example, a number of SSB beams in an SSB burst set is transmitted periodically within an interval (e.g., about 5 ms) and/or depends on a carrier frequency. In addition, for example, an SSB burst contains 4 SSBs for one portion of frequency range 1 (FR1) (e.g., less than or equal to about 3 GHz), 8 SSBs for another portion of FRI (e.g., between about 3 GHz and about 6 GHz), and 64 SSBs for frequency range (FR2). Moreover, for example, certain SSBs are transmitted as on-demand SSBs (OD-SSBs), including, e.g., a subset of SSBs in a burst. Furthermore, for example, OD-SSBs are transmitted aperiodically, semi-persistently, or periodically with certain periodicity. Additionally, for example, transmission of OD-SSBs is triggered by the NW node and/or a WTRU (e.g., via transmission of an UL Wake-Up Signal (WUS), or the like). Still further, for example, one or SSBs include slim and/or lean SSBs, including, e.g., PSS only, PSS and SSS-only, PBCH, or a subset of MIB-only.

For example, CSI-RS includes at least one of the following: CSI-RS resource set (ID), CSI-RS resource (ID/index), resource mapping, power control offset values (e.g., with respect to PDSCH, SSB, or the like), scrambling ID, periodicity, offset information, QCL information, combinations of the same, or the like. Also, for example, CSI-RS is transmitted in DL by the NW node as CSI-RS beams, e.g., via different resource types including periodic, semi-persistent and aperiodic.

For example, CSI includes at least one of the following: channel quality index (CQI), rank indicator (RI), precoding matrix index (PMI), an L1 channel measurement (e.g., reference signal received power (RSRP) such as L1-RSRP, signal to interference and noise ratio (SINR), or the like), CSI-RS resource indicator (CRI), SS/PBCH block resource indicator (SSBRI), layer indicator (L1), any other measurement quantity measured by the WTRU from the configured CSI-RS or SS/PBCH (SSB) block, combinations of the same, or the like.

For example, channel conditions include any conditions relating to a state of a radio and/or channel. Also, for example, one or more channel conditions are determined by a WTRU. Further, for example, the one or more channel conditions are determined by the WTRU from at least one of a WTRU measurement. Further, for example, the WTRU measurement includes at least one of L1 and/or SINR and/or RSRP, CQI and/or modulation and coding scheme (MCS), channel occupancy, RSSI, power headroom, exposure headroom, L3/mobility-based measurements (e.g., RSRP, reference signal received quality (RSRQ), s-measure, or the like), a radio link messaging (RLM) state, a channel availability in unlicensed spectrum (e.g., whether the channel is occupied based on determination of a listen before talk (LBT) procedure or whether the channel is deemed to have experienced a consistent LBT failure, or the like), combinations of the same, or the like.

In certain representative embodiments, one or more processes include at least one of identifying and/or utilizing one or more L1 measurements, identifying and/or utilizing one or more RRM reports, cell switching, handover execution, identifying and/or determining RAT applicability, combinations of the same, or the like.

For example, one or more L1 measurements include at least one of a measurement of RSRP, RSRP, RSSI, combinations of the same, or the like, e.g., performed by one or more WTRUs of at least one of a cell, a beam, a set of cells, a set of beams, combinations of the same, or the like. Also, for example, the one or more L1 measurements are similar to one or more L3 measurements reported in RRM, e.g., with differences in filtering, reference signals measured, reporting mechanisms, or the like.

For example, one or more L1 measurements apply to RRM reporting. Also, for example, one or more measurements refer to L1 measurements for LTM. Further, for example, RRM and/or L3 measurements are provided. In addition, for example, other measurements are provided, e.g., measurements of speed, location, height, traffic, combinations of the same, or the like.

For example, LTM cell switching applies to one or more types of handover execution. Also, for example, LTM cell switching refers to L1/2 triggered mobility. Further, for example, L1/2 triggered mobility includes a preconfigured RRC configuration. In addition, for example, a preconfigured RRC configuration is applied when a WTRU receives an indication. Moreover, for example, the indication includes using MAC CE or when a certain condition is met at the WTRU. Furthermore, for example, one or more additional technologies and solutions apply to an RRC reconfiguration, an RRC conditional reconfiguration, as well as any other type of mobility procedure.

For example, RAT are provided. Also, for example, one or more terms, one or more channels, and protocol design for 5G NR are provided. Further, for example, one or more methods, e.g., for 5G NR, apply to any cellular network, such as a 6G 3GPP system. In addition, for example, in the context of 6G and/or one or more future generation wireless networks, one or more functions may or may not be necessary, depending on, e.g., system architecture, protocol design, physical channel design, or the like. Moreover, for example, a system operates using a general principle that configurations are provided by an upper (e.g., RRC) layer apply to multiple target cells, beam, and/or TRPs, and the lower layer (e.g., MAC, L1, or the like) controls switching between the configurations.

For example, one or more solutions herein are described in terms of inter-RAT mobility. Also, for example, inter-RAT mobility is provided between 5G NR and a new radio access technology for 6G communications. Further, for example, the term “6G NR” refers to a new RAT for 6G. In addition, for example, naming conventions are not yet defined at the time of the present application; therefore, terms such as inter-RAT, 6G NR, or the like, are used interchangeably with any other term used (e.g., present or future) to describe inter-RAT functionality, 6G RATs, or the like. Moreover, for example, although one or more solutions refer to interworking between 5G NR and 6G NR, the one or more solutions are applied to mobility between any two RATs, whereby at least one of the RATs uses an LTM or similar mobility procedure (e.g., LTE and 6G NR, LTE and 5G NR, or the like).

For example, one or more of the solutions described herein perform mobility between different RATs. Also, for example, mobility is provided between standalone 6G carriers and 5G and/or 6G MRSS carriers. Further, for example, where one or more candidate cells, one or more target cells, one or more measurements, or the like, are described, the one or more candidate cells, the one or more target cells, the one or more measurements, or the like apply to any one or more beams, one or more cells, one or more physical resources, one or more measurements, one or more procedures, or the like, on a separate RAT than the RAT on which the WTRU is currently connected. In addition, for example, to “perform LTM” refers to “perform LTM from 5G to 6G” or the like.

In certain representative embodiments, one or more processes include at least one of the following: one or more LTM candidate configurations, one or more LTM execution triggers, one or more RACH-less CHO and/or early TA acquisitions, one or more TA validations, one or more WTRU based TA calculation reports, one or more beam refinements on one or more target cells before and/or during one or more handovers, one or more reports of one or more CSI-RS measurements, one or more enabling CSI-RS measurements, one or more configured grand activations, one or more hyper cells, one or more network measurements, one or more UL reference signals, one or more cell switches, one or more inter-RAT measurements, one or more inter-RAT mobility procedures, one or more prioritizations of one or more RATs, combinations of the same, or the like.

In certain representative embodiments, one or more processes include one or more LTM candidate configurations. For example, a gNB (e.g., a centralized unit (CU) in case of CU/distributed (DU) split architecture, where, for example, RRC resides in CU, or the like) configures one or more potential LTM candidates using RRC signaling. Also, for example, a WTRU receives one or more LTM candidate configurations using an RRC Reconfiguration message (e.g., during the “LTM candidate preparation” phase shown in FIG. 2). Further, for example, the WTRU stores the one or more LTM candidate configurations to later apply upon receiving an indication using L1/2 signaling (e.g., MAC CE, or the like) to perform a cell switch (e.g., in the “LTM execution” phase shown in FIG. 2).

In addition, for example, the configuration of one or more potential LTM candidates includes one or more candidate sets. Moreover, for example, a first set of candidates are suitable for a first path (e.g., a WTRU is being transported in a vehicle that turns left and takes a first road, or the like) and a second set of candidates are suitable for a second path (e.g., the WTRU being transported in the vehicle turns right and takes a second road, or the like).

Furthermore, for example, one, more, or all of the candidate sets of information are broadcast in system information. Additionally, for example, upon receiving an indication in dedicated signaling (e.g., RRC Reconfiguration, or the like), which refers to one or more LTM candidate configurations (e.g., using an index, identifier, or the like), the WTRU enables pre-configuration of the one or more LTM candidate configurations via the one or more broadcast sets of information.

Still further, for example, one or more LTM candidate configurations includes one or more subsets of potential cells in a specific area (e.g., all cells belonging to the CU with which the WTRU is currently connected or cells within a particular geographical area, or the like). Even further, for example, the cells within the particular geographical area have not yet been detected or measured by the WTRU, but are configured in advance. Yet further, for example, after initial configuration of one or more LTM candidate configurations, the WTRU receives an update to the configuration to modify, add, remove, and/or replace any part of the one or more LTM candidate configurations.

For example, the WTRU receives an indication to enable and/or disable some or all of the LTM configurations. Also, for example, if it is predicted that the WTRU mobility would be better handled using L3 (e.g., RRC measurement report, RRC reconfiguration, conditional reconfiguration, or the like), then LTM is disabled. Further, for example, if it is predicted that LTM would better suit the WTRU mobility, then LTM is enabled (e.g., a previously configured and disabled LTM configuration may be re-enabled, or the like).

In addition, for example, a configuration in one solution is based on a prediction model internal to, and determined by, a network (e.g., gNB). Moreover, for example, a prediction is based on what a NW prediction model, or the like determines to be one or more most likely paths for one or more WTRUs.

Furthermore, for example, one or more candidate cell configurations contain one or more portions of information to complete a reconfiguration (e.g., handover, or the like) to a candidate cell, such as one or more channel configurations (e.g., Physical Random Access Channel (PRACH), Dedicated Physical Control Channel (DPCCH), Physical Downlink Shared Channel (PDSCH), or the like), Control Resource Set (CORESET), Bandwidth Part (BWP), security parameters, L2 parameters (e.g., MAC, Radio Link Channel (RLC), Packet Data Convergence Protocol (PDCP), or the like), radio bearer configurations, or the like.

In certain representative embodiments, one or more processes include one or more LTM execution triggers. For example, a LTM execution trigger refers to a condition for performing LTM (e.g., a CHO trigger or measurement report trigger, or the like). Also, for example, the LTM execution trigger is configured or indicated by a network to the WTRU. Further, for example, the LTM execution trigger is estimated and/or determined by the WTRU. In addition, for example, a trigger is based on at least one of the following: time, radio quality measurement, predicted radio quality, position, L3 measurement event, L1 measurement event and/or condition, a time and/or location based condition, a combination (e.g., L3, L1, time, and/or location-based) of conditions and/or events, a predicted event, an explicit indication from the network, a network performance metric, an evaluation metric, combinations of the same, or the like.

For example, a trigger is based on time. Also, for example, a trigger is based on absolute or relative time measured time at a WTRU. Further, for example, a trigger is based on a system frame number (SFN). In addition, for example, a trigger is based on a subframe number.

For example, a trigger is based on a radio quality measurement or predicted radio quality of one or more of serving cells or target cells. Also, for example, a trigger is based on at least one of RSRP (e.g., of a beam and/or a cell), RSRQ (e.g., of a beam and/or a cell), cri-RI-PMI-CQI, cri-RI-il, cri-RI-il-CQI, cri-RI-CQI, cri-RSRP, ssb-Index-RSRP, cri-RI-L1-PMI-CQI, combinations of the same, or the like.

For example, a trigger is based on a position. Also, for example, a trigger is based on an area (e.g., defined by a reference point and a radius, or the like), or a range of co-ordinates. Further, for example, a trigger is based on a distance threshold from a reference location.

For example, a trigger is based on any L3 measurement event including at least one of Event A1 (e.g., serving becomes better than threshold), Event A2 (e.g., serving becomes worse than threshold), Event A3 (e.g., neighbor becomes offset better than SpCell), Event A4 (e.g., neighbor becomes better than threshold), Event A5 (e.g., SpCell becomes worse than threshold1 and neighbor becomes better than threshold2), Event A6 (e.g., neighbor becomes offset better than SCell), Event B1 (e.g., inter-RAT neighbor becomes better than threshold), Event B2 (e.g., PCell becomes worse than threshold1 and inter-RAT neighbor becomes better than threshold2), combinations of the same, or the like.

For example, a trigger is based on any L1 measurement event and/or condition including at least one of any event defined that utilizes L1 one or more beam measurements to evaluate whether a criteria and/or a condition is met, Event LTM1 (e.g., beam of serving cell becomes better than absolute threshold), Event LTM2 (e.g., beam of serving cell becomes worse than absolute threshold), Event LTM3 (e.g., beam of candidate cell becomes amount of offset better than beam of serving cell), Event LTM4 (e.g., beam of candidate cell becomes better than absolute threshold), Event LTM5 (e.g., beam of serving cell becomes worse than absolute threshold1 and beam of candidate cell becomes better than another absolute threshold2), combinations of the same, or the like.

For example, a trigger is based on any time or location based condition including at least one of a time measured at a WTRU within a duration from threshold, a distance between a WTRU and referenceLocation1 above threshold1 and a distance between the WTRU and referenceLocation2 below threshold2, a distance between a WTRU and a serving cell moving reference location is above threshold and a distance between the WTRU and a moving reference location is below threshold2, combinations of the same, or the like.

For example, a trigger is based on any combination of L3, L1, time, and location-based conditions and/or events. Also, for example, a trigger is based on a time measured at a WTRU within a duration from a threshold, and a beam of a candidate cell becomes better than an absolute threshold, or the like. Further, for example, a trigger is based on a distance between a WTRU and referenceLocation1 above threshold1 and a distance between the WTRU and referenceLocation2 below threshold2, and a beam of a candidate cell becomes an amount of offset better than a beam of a serving cell. In addition, for example, a trigger is based on a distance between a WTRU and a serving cell moving reference location above threshold1 and a distance between the WTRU and a moving reference location below threshold2, a beam of a serving cell becomes worse than absolute threshold1, and a beam of a candidate cell becomes better than another absolute threshold2.

For example, a trigger is based on one or more predicted events using one or more measurement quantities. Also, for example, a trigger is based on any combination of one or more sets of measured and/or predicted CSI information.

For example, a trigger is based on one or more explicit indications from one or more networks. Also, for example, a WTRU enable CSI reporting based on an explicit indication (e.g., a MAC CE, or the like) received from a network, and then the WTRU executes an LTM cell switch upon receiving a second MAC CE from the network.

For example, a trigger is based on one or more network performance metrics. Also, for example, a trigger is based on one or more measured, predicted, and/or estimated throughput, error rate, buffer status, and/or QoS parameters.

For example, a trigger is based on one or more evaluation metrics. Also, for example, a trigger is based on at least one of a time-to-trigger, a hysteresis, an offset (e.g., a radio quality measurement offset, or the like), a measurement filtering configuration, combinations of the same, or the like.

For example, a trigger includes one or more conditions under which a WTRU is allowed to perform one or more actions related to LTM. Also, for example, the WTRU performs at least one of the following procedures: early TA acquisition, switching off of CSI reporting, switching on and/or updating a CSI reporting configuration, performing LTM cell switching, monitoring PDCCH on a target cell, performing beam failure detection (BFD) and/or radio link monitoring (RLM) on a target cell, activating and/or deactivating one or more SCells, combinations of the same, or the like.

For example, a trigger includes early TA acquisition. Also, for example, a WTRU triggers a RACH to a target LTM cell. Further, for example, a WTRU receives a TA value in a random access response (RAR). In addition, for example, RAR is based on information from a target cell and/or via a source cell. Moreover, for example, a WTRU receives a TA value in a MAC CE triggering a cell switch. Furthermore, for example, a WTRU performs power ramping and/or preamble retransmission on a target if a RAR and/or MAC CE is not received. Additionally, for example, a WTRU acquires a TA value of a candidate LTM cell by measurement, and/or triggers when complete. Still further, for example, the WTRU supports and/or is configured with WTRU-based TA measurement, whereby the WTRU acquires one or more TA values of one or more candidate cells by measurement.

For example, a trigger includes switching off CSI reporting. Also, for example, a WTRU is allowed and/or required to switch off CSI reporting in order to reduce reporting overhead in an uplink. Further, for example, CSI reporting is reduced rather than switched off. In addition, for example, a reduced number of cells and/or beams are reported. Moreover, for example, a reduced frequency of reporting is provided. Moreover, for example, a WTRU resumes CSI reporting when a condition is no longer met.

For example, a trigger includes switching on and/or updating a CSI reporting configuration. Also, for example, the WTRU is required to perform and/or report CSI measurements on one or a subset of LTM candidate cells during a window.

For example, a trigger includes performing LTM cell switching. Also, for example, a trigger includes specifying one or more conditions and/or criteria under which a WTRU is allowed to trigger LTM cell switching.

For example, a trigger includes monitoring PDCCH on a target cell. Also, for example, a WTRU is configured to monitor on a target cell for a DCI scheduling PDSCH and/or indicating one or more actions on the target cell (e.g., initiate a cell switch procedure).

For example, a trigger includes performing BFR and/or RLM on a target cell. Also, for example, a WTRU is configured to monitor BFD resources on a target cell, and/or perform RLM on a target cell during a window.

For example, a trigger includes activating and/or deactivating one or more SCells. Also, for example, the WTRU is configured with one or more specific SCells, which should be active or not active during a window.

In certain representative embodiments, one or more processes include one or more instances of RACH-less CHO and/or early TA acquisition. For example, to enable RACH-less CHO, the WTRU is not required to transmit a random access preamble or perform a random access procedure on a target cell following a reconfiguration trigger. Also, for example, a WTRU performs PDCCH reception and/or uplink transmission using a TA already provided. Further, for example, a WTRU performs an early TA acquisition procedure with one or more candidate cells before receiving a cell switch command and/or before triggering a conditional reconfiguration.

In addition, for example, early TA acquisition is performed using contention-free random access (CFRA) triggered by a PDCCH order from the source cell. Moreover, for example, the WTRU transmits a preamble towards a candidate cell. Furthermore, for example, the allocated CFRA resource is identified in the PDCCH order. For example, preamble resources are shared among multiple WTRUs in the RRC configuration. Also, for example, a source gNB dynamically indicates which WTRU uses a resource any specific time.

Additionally, for example, one or more RACH-less CHO procedures are performed upon receiving a MAC CE indicating to perform a RACH transmission on a target cell. Still further, for example, one or more RACH-less CHO procedures are performed by transmitting using a contention-based random access (CBRA) preamble.

Even further, for example, to minimize the data interruption of the source cell due to CFRA towards one or more candidate cells, a WTRU does not receive RAR at all. Yet further, for example, a source cell triggers a preamble retransmission and/or power ramping using another PDCCH order.

Also, for example, a WTRU receives a TA value from a target cell in a RAR. Further, for example, a WTRU receives a TA value from a source cell in a RAR. In addition, for example, if a WTRU does not receive a RAR in response to transmitting a preamble, the WTRU retransmits a preamble using a higher transmission power.

Moreover, for example, a WTRU stores a received TA value to be used later when a reconfigure trigger occurs. Furthermore, for example, a WTRU stores a TA value for a limited period of time. Additionally, for example, a WTRU triggers or is triggered to perform a new TA acquisition procedure when time expires.

Still further, for example, a WTRU receives and/or stores multiple TA values associated with more than one cell. Even further, for example, a WTRU obtains a TA value of a target cell by measurement.

Yet further, for example, if a WTRU has stored a valid TA value of a candidate cell when a cell switch is triggered towards the candidate cell, then the WTRU performs a RACH-less handover. Also, for example, a WTRU executes LTM upon determining that a measured radio quality of a target cell is above a threshold.

Further, for example, the WTRU supports and is configured with WTRU-based TA measurement. In addition, for example, the WTRU acquires one or more TA values of one or more candidate cells by measurement. Moreover, for example, if a cell switch command does not contain a TA value, and a WTRU has acquired a TA measurement, the WTRU performs a RACH-less handover.

In certain representative embodiments, one or more processes include one or more TA validations. For example, a WTRU determines a validity of one or more received and/or stored TAs based on one or more conditions. Also, for example, a WTRU determines a validity of one or more received and/or stored TAs based on a validity timer pre-configured to be used a TA value.

Further, for example, a WTRU determines a validity of one or more received and/or stored TAs based on a validity timer received with a TA value. In addition, for example, a WTRU determines a validity of one or more received and/or stored TAs based on a condition on the DL cell timing of the source cell and the DL cell timing of the candidate cell for which TA is received and/or stored. Moreover, for example, a WTRU considers the TA valid while the difference of the DL cell timing of the source and candidate cell is less than a configured threshold. Furthermore, for example, a WTRU considers the TA valid while the difference of the DL cell timing of the source and candidate cell is within a configured range.

Furthermore, for example, a WTRU determines a validity of one or more received and/or stored TAs based on a condition on the DL cell timing of the candidate cell. Additionally, for example, a WTRU considers the TA valid if the difference of the DL cell timing of the target cell at the time of the TA reception is not different by more than a certain configured value and/or range than the current DL cell timing of the same target cell.

Still further, for example, a WTRU determines a validity of one or more received and/or stored TAs based on a condition on the WTRU mobility. Even further, for example, a WTRU considers the TA valid if it is static (e.g., not moving, or the like) or moving below a certain configured speed threshold.

Yet further, for example, a WTRU determines a validity of one or more received and/or stored TAs based on a condition and a WTRU location. For example, a WTRU considers the TA valid if it has determined that it has not changed its location by more than a certain configured threshold (e.g., x meters, or the like) after the TA acquisition.

For example, a WTRU determines a validity of one or more received and/or stored TAs based on a condition that a WTRU-based TA measurement is available and a cell quality or beam quality measurement is above a threshold.

In certain representative embodiments, one or more processes include one or more WTRU based TA calculation reports. For example, a WTRU triggers an event when a WTRU-based TA acquisition has been completed. Also, for example, a WTRU transmits a MAC change request (CR), CSI, or other uplink indication to a source cell or a candidate cell when a TA has been obtained based on WTRU measurement. Further, for example, a WTRU triggers an event based on a measurement criteria (e.g., RSRP or any one or more of the triggers listed herein, or the like). In addition, for example, a WTRU transmits a corresponding report only if a TA has additionally been obtained. Moreover, for example, a WTRU transmits a corresponding report only if a TA is available due to a prior WTRU-based TA acquisition. Furthermore, for example, a report or an LTM execution trigger caused due to a measurement based event or trigger is delayed until a WTRU-based TA acquisition is completed. Additionally, for example, a measurement event (e.g., a beam RSRP is above a threshold, or the like) causes a WTRU to initiate a WTRU-based TA acquisition. Still further, for example, a trigger is executed when both a measurement event is satisfied and a TA has been obtained.

Even further, for example, in response to receiving a report from a WTRU (e.g., WTRU-based TA acquisition has been performed and a beam or cell measurement is above a threshold, or the like), a network transmits to the WTRU a command to enable conditional LTM evaluation (e.g., in a MAC CE). Yet further, for example, a WTRU receives a command, and based on a content of the command, the WTRU enables conditional LTM evaluation based on determination of one or more measurement conditions.

In certain representative embodiments, one or more processes include one or more beam refinements on a target cell before and/or during a handover. For example, a WTRU performs beam refinement on a target cell before and/or during a handover and/or before the WTRU accesses the target cell. Also, for example, a WTRU first performs measurement of SSB resources, then selects a subset of CSI-RS resources to measure based on SSB measurements (e.g., based on the best SSB measured, or the like). Further, for example, a WTRU performs measurements on a selected subset of CSI-RS resources and determines a best CSI-RS resource. In addition, for example, a selected best CSI-RS resource is indicated before a handover takes place (e.g., to a source cell, or the like), or upon initial access (e.g., to a target cell, or the like), rather than performing the beam refinement only after a connection to a target cell is completed.

In certain representative embodiments, one or more processes include one or more CSI-RS measurement reports. For example, a WTRU reports measurements of a subset of CSI-RS resources using CSI reporting on PUCCH to a source cell. Also, for example, a report is transmitted using a MAC CE, an RRC measurement report, or any other type of uplink signaling. Further, for example, a report includes at least one of RSRP (e.g., for a beam and/or cell), RSRQ (e.g., for a beam and/or cell), cri-RI-PMI-CQI, cri-RI-il, cri-RI-il-CQI, cri-RI-CQI, cri-RSRP, ssb-Index-RSRP, cri-RI-L1-PMI-CQI, combinations of the same, or the like.

In certain representative embodiments, one or more processes include one or more enabling CSI-RS measurements. For example, a WTRU determines, based on a trigger of a subset of CSI-RS to measure. Also, for example, a WTRU determines based on a pre-configured association (e.g., configured by RRC, or the like) between SSB and CSI-RS resources. Further, for example, a WTRU determines based on an indication of an SSB and/or determines a best SSB from performed SSB measurements.

In addition, for example, a subset of CSI-RS is indicated explicitly in a RAR (e.g., using a pointer to one of multiple subsets, or the like) and/or may be indicated implicitly (e.g., the WTRU enables a subset of CSI-RS depending on a reported or indicated SSB when the RAR is received, or the like). Moreover, for example, a WTRU enables a subset of CSI-RS measurements when the WTRU receives a PDCCH order triggering early TA acquisition, while the RAR or MAC CE containing a TA in response to the PRACH preamble transmission for TA acquisition activates the configured grant.

Furthermore, for example, CSI-RS measurements are configured temporarily. Additionally, for example, a WTRU activates CSI-RS measurements for a certain time period, or a certain number of reports, which are configured or predefined. Still further, for example, a WTRU deactivates CSI-RS measurements when a best SSB changes or when an SSB or CSI-RS measurement goes below a threshold.

In certain representative embodiments, one or more processes include one or more configured grant activations. For example, a WTRU receives an indication to activate a grant from either a source cell or a target cell (e.g., a type 2 configured grant). Also, for example, a first cell configures a grant. Further, for example, a second cell performs at least one of activating a grant. In addition, for example, a second cell provides an explicit grant (e.g., a direct indication of the grant to use, or the like). Moreover, for example, one or more pointer to one or more preconfigured grants (e.g., previously configured by RRC, or the like) are provided.

Furthermore, an indication of a grant includes a pointer to a configured grant corresponding to a reported SSB. Additionally, for example, an indication of a grant includes a set of configured grants corresponding to multiple CSI-RS associated with a reported SSB.

Still further, for example, a configured grant activation is received in at least one of a PDCCH order (e.g., triggering TA acquisition, or the like), in a MAC CE (e.g., triggering LTM, or the like), in a RAR (e.g., received from the source or the target, containing a TA value to use for RACH-less handover, or the like), or the like.

Even further, for example, a WTRU autonomously activates a configured grant based on a condition. Yet further, for example, a WTRU autonomously activates a configured grant based on one or more of the LTM execution triggers listed herein.

In certain representative embodiments, one or more processes include one or more hyper cells. For example, in architectures where a presence of a “cell” is hidden from a WTRU, the network adapts all or part of a network configuration to a configuration the WTRU is provided with. Also, for example, one or more individual beams are configured to a WTRU without the WTRU needing to have visibility of a physical location of the one or more individual beams. Further, for example, by providing large scale coordination of TRPs, a WTRU experiences cell center-like data transmission and/or reception across a network. In addition, for example, for moving one or more WTRUs, one or more serving TRP are dynamically selected and enabled without indicating a cell switch to the one or more WTRUs (e.g., the network adapts to the WTRU configuration, or the like). Moreover, for example, one or more different TRPs within a “hyper-cell” transmit identical downlink synchronization signals, and/or transmit using a single resource configuration. Furthermore, for example, a WTRU is configured to measure one or more “resources” in a downlink and/or transmits using the resources in an uplink, which are common to more than one TRP and for which the WTRU does not need to know a physical location of the signals. Additionally, for example, an uplink SRS is provided for a network to determine a best uplink (e.g., when an uplink only TRP requires such, or the like).

In certain representative embodiments, one or more processes include one or more network measurements. For example, the one or more network measurements include at least one of an uplink reference signal, a cell switch, one or more inter-RAT measurements, inter-RAT mobility, prioritization of one or more RATs, combinations of the same, or the like.

Also, for example, one or more processes include one or more uplink reference signals. Further, for example, SRS is a reference signal transmitted by a WTRU in an uplink. In addition for example, an SRS is used by a network (e.g., gNB, or the like) to estimate an uplink channel quality. Moreover, for example, SRS is used to provide information to a network about multipath fading, scattering, Doppler, and power loss of a transmitted signal. Furthermore, for example, one or more SRSs are uplink physical signals employed by a WTRU for uplink channel sounding, including channel quality estimation and synchronization. Additionally, for example, unlike demodulation reference signals (DM-RS), SRS is not associated with any physical uplink channels, and SRSs support uplink channel-dependent scheduling and link adaptation. Still further, for example, SRS assists with codebook-based closed-loop spatial multiplexing, control uplink transmit timing, reciprocity-based downlink precoding in multi-user MIMO setups, quasi co-location of physical channels and reference signals, or the like.

For example, a network perform measurements on one or more SRSs transmitted by one or more WTRUs on one or more TRPs. Also, for example, a WTRU selects SRS resources for TRPs, which provide one or more best measured downlink beams. Further, for example, a WTRU transmits using more than one SRS resource representing multiple potential target TRPs. In addition, for example, a WTRU includes an indication of a downlink measurement value (e.g., RSRP, or the like). Moreover, for example, a WTRU includes an indication of only a downlink measurement associated with an SRS resource selection, and/or includes an indication of multiple downlink measurements (e.g., the best N beams, or the like).

For example, a network performs uplink measurements on one or more TRPs. Also, for example, a network coordinates measurements, e.g., by exchanging measurement information between a network node or with a central node. Further, for example, a network determines, based on measurement coordination, to select a new TRP or cell for a WTRU. In addition, for example, a WTRU transmits an uplink SRS to only one TRP and includes downlink measurements. Moreover, for example, a network coordinates (e.g., only) between a target TRP and a source TRP, rather than multiple potential targets.

For example, a network determines, based on measuring SRS resource set transmissions (e.g., uplink beam sweep, or the like) using resources determined by a WTRU based on downlink measurements, a best fine beam to configure the WTRU with upon cell or TRP change.

For example, an intermediate node (e.g., a relay, or the like) is employed to act as a network node. Also, for example, an intermediate node performs measurements of a WTRU transmitted uplink SRS and conveys measurements to a traditional (e.g., fixed TRP, or the like) network node.

For example, a network node is configured to operate as an uplink only TRP.

For example, a network node is deployed on an arial vehicle (e.g., drone, or the like) or on a satellite (e.g., non-terrestrial network (NTN) cell, or the like).

In certain representative embodiments, one or more processes include one or more cell switching operations. For example, a cell switch command is received in a downlink signal such as DCI, MAC CE, or the like. Also, for example, a cell switch command is received from a source cell (e.g., like NR, or the like) or from a target cell (e.g., a cell determined to be the best cell, or the like). Further, for example, when a hyper cell is used, a cell is switched without notifying a WTRU. In addition, for example, a network configures, based on uplink measurements, to use a new TRP with a same configuration as a previous one.

Moreover, for example, an uplink and a downlink connection are separately managed. Furthermore, for example, mobility based on reported downlink measurements is used to manage downlink channels and TRPs. Additionally, for example, a network selects uplink channels and TRPs based on uplink measurement signals.

In certain representative embodiments, one or more processes include one or more inter-RAT measurements. For example, one or more measurements on a new RAT (e.g., 6G, or the like) are similar to those on 5G NR (e.g., SSB, a CSI-RS measurement resource structure, CSI requirements, or the like). Also, for example, a new RAT requires a different type of measurements. Further, for example, a type of measurements based on a PSS/SSS channel is provided. In addition, for example, a new type of channel or resource structure is provided.

Moreover, for example, for inter-RAT L1 events, for a different measurement resource structure, a comparison of measurement results using signals of different types is provided. Furthermore, for example, separate measurement thresholds are used depending on a RAT or a signal type. Additionally, for example, a network configures an offset or a means of converting a measurement result to a format, which is compared to another type of result. Still further, for example, measurements are performed across RATs in a same band (e.g., for MRSS, or the like) and on a same carrier. Even further, for example, if a WTRU has multiple receivers, the WTRU performs measurements across RATs without measurement gaps to re-tune a receiver. Yet further, for example, where different carriers or bands that the WTRU measures use a single receiver, measurement gap configuration is provided. For example, in implementations where 6G shares a same or similar front-end as 5G, each RAT uses a same carrier but with a different signal or channel structure.

Also, for example, one or more measurements on another RAT are configured to use more than one configuration. Further, for example, 6G measurements are configured with multiple periodicities, and/or using multiple different sets of reference signals. In addition, for example, a WTRU, when a measured quality of an inter-RAT carrier is relatively low, utilizes a less frequent measurement or set of resources (e.g., resources with a wider beam, or the like). Moreover, for example, when a measured quality of an inter-RAT carrier is relatively high, a WTRU performs more frequent measurements, e.g., on a set of resources which occur with shorter periodicity or with a narrower beam.

In certain representative embodiments, one or more processes include inter-RAT mobility. For example, a WTRU performs different mobility procedures when performing handover within one RAT and across RATs. Also, for example, a WTRU is configured to perform a CHO to one or more candidate cells within 5G. Further, for example, a WTRU is configured to perform explicit (e.g., L1/2 triggered, or the like) handover to cells on a 6G RAT.

Further, for example, for co-located base stations, a downlink or an uplink early synchronization procedure utilizes a different format or numerology for channels. In addition, for example, a WTRU is configured with one or more candidate TCI states for a different RAT in order to enable early downlink synchronization. Moreover, for example, a WTRU is configured with an uplink channel (e.g., PRACH, or the like) in order to transmit a signal to a candidate cell on another RAT, e.g., in order to derive uplink timing to enable early uplink synchronization. Furthermore, for example, a combination of LTE and 5G/6G MRSS is provided, and LTM is provided to perform mobility from LTE to 5G, 6G, or a shared 5G/6G MRSS band. Additionally, for example, a combination of 5G and 6G MR-DC includes, e.g., standalone 6G in a dedicated band, standalone 6G in an MRSS band, EN-DC with a Master Cell Group (MCG) in LTE and a Secondary Cell Group (SCG) in 5G or 6G, or the like.

Still further, for example, a WTRU is pre-configured with candidate cell configurations on a second RAT while connected to a first RAT (e.g., similar to LTM, or the like). Even further, for example, a WTRU receives one or more candidate configurations of a second RAT while connected to the second RAT, which are stored when moving to a first RAT and indicated by the first RAT when performing inter-RAT cell switch. Yet further, for example, for inter-RAT change, one or more security keys are indicated and/or derived on a second RAT based on an indication or a derivation method using keys in a first RAT.

For example, both 5G RAN and 6G RAN use a common core network (e.g., 5GC, an evolved 5GC, or the like). Also, for example, where a common core network is utilized, a core network does not require relocation. Further, for example, where separate core networks are provided, a CN relocation is performed.

In addition, for example, a separate MAC CE is received from a first RAT or a second RAT to configure measurements on the second RAT. Moreover, for example, a WTRU is connected to a first RAT, and receives a MAC CE from the first RAT or a second RAT, which initiates a lower layer of the second RAT in the WTRU to be configured for measurements or early synchronization. Furthermore, for example, a WTRU receives a first MAC CE on a first RAT, to initiate monitoring of a downlink channel on a second RAT. Additionally, for example, a WTRU receives a second MAC CE on a second RAT, which configures certain parameters such as measurement resources, TCI state, or the like, or initiates a procedure on the second RAT. Still further, for example, a TCI state configuration of a second RAT is received from the second RAT, e.g., contained in SSB information received from the second RAT. Even further, for example, a WTRU maintains a separate TCI state list for a second RAT, or derives this information based on a mapping from a first RAT TCI state list and a candidate configuration index or identity.

For example, a second RAT candidate configuration is received in a transparent container via a first RAT.

For example, a PDCCH order is received from a first RAT for initiating RACH to a second RAT. Also, for example, a MAC CE is received from a first RAT or a second RAT to indicate a candidate configuration to apply for the second RAT and initiate the inter-RAT cell switch based on a stored candidate configuration.

In certain representative embodiments, one or more processes include one or more prioritizations of one or more RATs. For example, a network steers 6G capable devices towards standalone 6G as a preference. Also, for example, capacity available on 6G carriers is utilized rather than devices sharing the same resources and capacity as a shared MRSS 5G/6G carrier or a 5G carrier, which would be serving devices not capable of 6G. Further, for example, for MRSS, fast cell switch is performed between 5G and 6G to make more efficient use of available shared resources.

In addition, for example, a WTRU is configured to perform measurements of a higher priority RAT regardless of a measurement result on a current cell or RAT. Moreover, for example, one or more inter-RAT measurements are performed at a first periodicity (e.g., relatively infrequently) while a measurement of a serving cell on a first RAT is above a threshold or a measurement of a cell on a second RAT is below a threshold. Furthermore, for example, if a measurement of a first RAT goes below a threshold, or if a measurement of a second RAT goes above a threshold, inter-RAT measurement is performed at a second periodicity (e.g., relatively frequently). Additionally, for example, a second RAT is always prioritized (e.g., because it is always measured) while saving power when conditions for handover to the second RAT are not preferable, and ensures that measurements are performed with higher reliability and performance when the conditions for handover to the second RAT become preferable (e.g., either due to preferential service on the second RAT, due to deteriorating coverage on the first RAT, or the like).

For example, a WTRU additionally and/or alternatively modifies one or more measurements and/or one or more procedures to perform in a first RAT. Also, for example, a WTRU monitors one or more conditions for performing CHO in a first RAT while a measurement of a serving cell on the first RAT is above a threshold or a measurement of a cell on a second RAT is below a threshold. Further, for example, monitoring for a CHO condition is stopped if a measurement of a first RAT goes below a threshold, or if a measurement of a second RAT goes above a threshold. In addition, for example, a WTRU monitors a higher number of cells, beams or measurement resources on a first RAT while a measurement of a serving cell on the first RAT is above a threshold or a measurement of a cell on the second RAT is below a threshold. Moreover, for example, a WTRU monitors a lower number of cells, beams or measurement resources on a first RAT if a measurement of the first RAT goes below a threshold, or if a measurement of a second RAT goes above a threshold. Furthermore, for example, a WTRU utilizes a condition based on a measurement of a first RAT or a second RAT to select one of multiple measurement configurations or mobility procedures on the first RAT or the second RAT. Additionally, for example, a WTRU selects one or more configurations based on a condition. Still further, for example, a WTRU reports a condition to a network, and the network indicates (e.g., using a MAC CE, or the like) which configuration to use.

For example, a condition includes at least one of the following: measurement (e.g., RSRP, RSRQ, or the like) of a cell or beam on a first RAT is below a threshold, measurement (e.g., RSRP, RSRQ, or the like) of a cell or beam on a second RAT is above a threshold, measurement (e.g., RSRP, RSRQ, or the like) of a cell or beam on a first RAT is greater than a cell or beam on a second RAT, a number of candidates for cell or beam measurements on a second RAT is above a threshold, a number of candidates for cell or beam measurements on a first RAT is below a threshold, a number of candidates for cell or beam measurements on a first RAT is less than a number of candidates for cell or beam measurements on a second RAT, combinations of the same, or the like.

For example, an action includes at least one of the following: perform measurements on a first RAT at a lower frequency or intensity (e.g., longer periodicity or fewer resources or carriers, or the like), perform measurements on a second RAT at a higher frequency or intensity (e.g., shorter periodicity or more resources or carriers, or the like), enable or disable measurements on certain resources or carriers on a first RAT or a second RAT, enable or disable certain measurement events, enable or disable certain measurement objects, enable or disable certain conditional handovers (e.g., conditional LTM, or the like), enable or disable certain candidate configurations, combinations of the same, or the like.

In certain representative embodiments, inter-RAT LTM is provided. For example, procedures are provided to enable LTM based handover from one RAT to another RAT. Also, for example, pre-configuration of inter-RAT candidate cells is provided. Further, for example, lower-layer triggered handover between RATs is provided. In addition, for example, inter-RAT early synchronization is provided. Moreover, for example, RACH-less handover between RATs is provided.

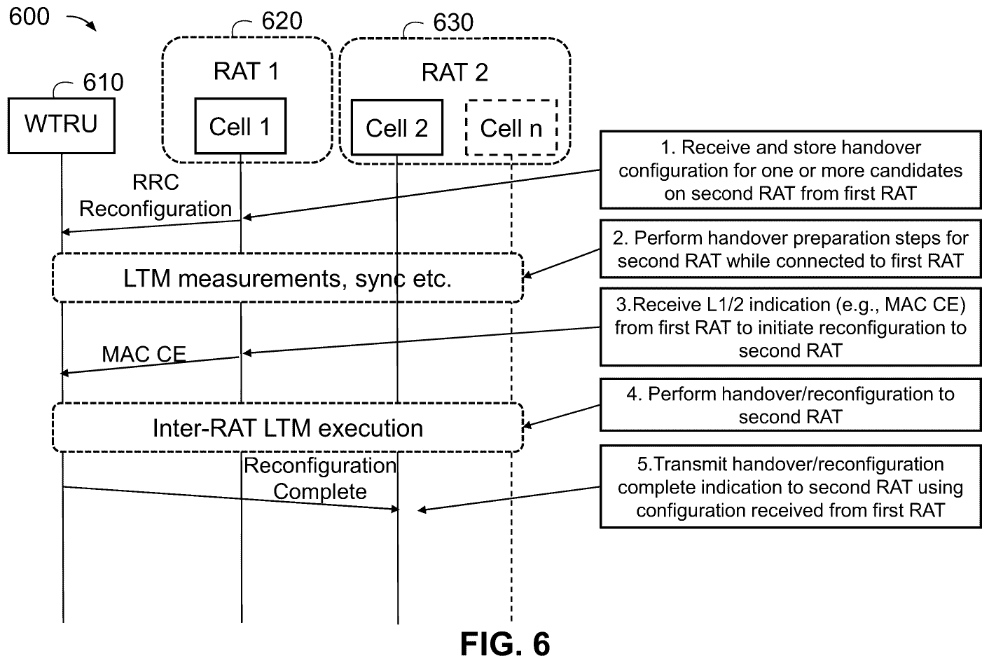

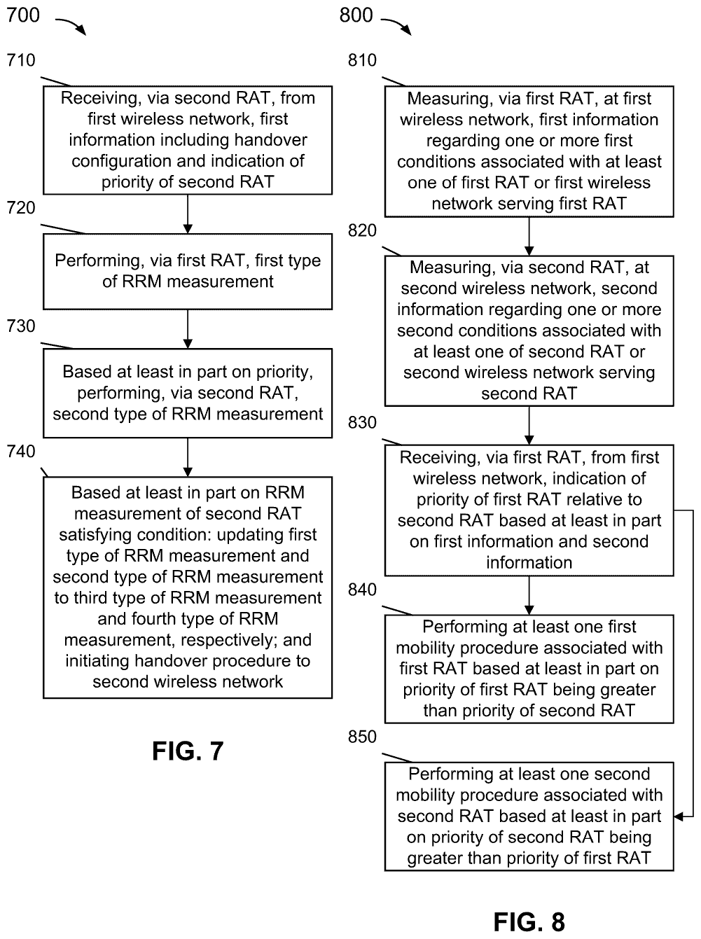

In certain representative embodiments, as shown in FIG. 6, a process 600 for inter-RAT LTM is provided including at least one of receiving and/or storing a handover configuration, performing handover preparation steps, receiving an L1/2 indication, performing a handover and/or reconfiguration, transmitting a handover and/or reconfiguration indication, combinations of the same, or the like.

For example, the process 600 for inter-RAT LTM includes receiving and storing a handover configuration for one or more candidates on a second RAT 630 from a first RAT 620 (e.g., at Step 1). Also, for example, a configuration is received on a target RAT (e.g., 6G, or the like), and stored while on NR to be used when returning, or the like. Further, for example, handover occurs from 5G NR to 6G NR, or the like. In addition, for example, handover occurs from LTE to 6G, or the like. Moreover, for example, handover occurs from DC, e.g., 5G LTM candidates with a 6G SCG.

For example, the process 600 for inter-RAT LTM includes performing handover preparation steps for a second RAT 630 while connected to a first RAT 620 (e.g., at Step 2). Also, for example, the handover preparation steps include inter-RAT L1 measurements, reporting, evaluation, CHO, or the like. Further, for example, the inter-RAT procedures include one or more types of RS, measurement, reporting, or the like. In addition, for example, the inter-RAT procedures include high level procedures for existing inter-RAT solutions based on L3. Moreover, for example, the handover preparation steps include inter-RAT downlink synchronization. Furthermore, for example, inter-RAT downlink synchronization includes TCI state based synchronization, or the like. Additionally, for example, the handover preparation steps include inter-RAT uplink synchronization. Still further, for example, the inter-RAT uplink synchronization includes one or more mechanisms in each RAT.

For example, the process 600 for inter-RAT LTM includes receiving an L1/2 indication (e.g., MAC CE, or the like) from the first RAT 620 to initiate reconfiguration to the second RAT 630 (e.g., at Step 3). Also, for example, a target is triggered by a WTRU 610 performing some or all of a monitoring of a DL on the target before HO. Further, for example, LTM is provided.

For example, the process 600 for inter-RAT LTM includes receiving performing a handover/reconfiguration to the second RAT 630 (e.g., at Step 4).

For example, the process 600 for inter-RAT LTM includes transmitting a handover and/or reconfiguration complete indication to the second RAT 630 using the configuration received from the first RAT 620 (e.g., at Step 5). Also, for example, for a DC, e.g., MCG is NR, and SCG setup completion is performed on the second RAT 630 while MCG is maintained on the first RAT 620. Further, for example, RACH-less inter-RAT handover is provided. In addition, for example, WTRU 610 performs uplink synchronization on the second RAT 630 (e.g., 6G, or the like) while on 5G (or MRSS carrier, or the like). Moreover, for example, WTRU 610 transmits a handover complete message to the second RAT 630 using timing information derived while on the first RAT 620.

In certain representative embodiments, interworking between new 6G deployments is provided. For example, LTM is utilized as a default mobility mechanism. Also, for example, existing LTE and/or NR deployments are provided. Further, for example, a fast switch mechanism is provided between RATs. In addition, for example, a fast switch mechanism is provided where 5G and 6G spectrum is shared (e.g., MRSS, or the like).

In certain representative embodiments, a method 700, performed via a first Radio Access Technology (RAT) of a first wireless network, is provided for configuring inter-RAT mobility prioritization associated with the first RAT of the first wireless network and a second RAT of a second wireless network. For example, the method 700 includes receiving 710, via the second RAT, from the first wireless network, first information including a handover configuration and an indication of a priority of the second RAT. Also, for example, the method 700 includes performing 720, via the first RAT, a first type of Radio Resource Management (RRM) measurement. Further, for example, the method 700 includes, based at least in part on the priority, performing 730, via the second RAT, a second type of RRM measurement. In addition, for example, the method 700 includes, based at least in part on the RRM measurement of the second RAT satisfying a condition: updating 740 the first type of RRM measurement and the second type of RRM measurement to a third type of RRM measurement and a fourth type of RRM measurement, respectively. Moreover, for example, the method 700 includes, based at least in part on the RRM measurement of the second RAT satisfying the condition: initiating a handover procedure to the second wireless network. Furthermore, for example, the priority is determined at the first wireless network. Additionally, for example, the indication of the priority includes information indicating at least one of: all 6G carriers, standalone 6G carriers, or a combination of carriers. Still further, for example, the handover configuration includes a first mobility procedure using the first type of RRM measurement associated with the first RAT. Even further, for example, the handover configuration includes a second mobility procedure using a second type of RRM measurement associated with the second RAT. Yet further, for example, the handover configuration includes the indication of the priority of the second RAT. For example, the handover configuration includes a condition for determining how to perform the second type of RRM measurement. Also, for example, the second type of RRM measurement satisfying the condition includes comparing a standalone 6G carrier measurement to a threshold. Further, for example, the first wireless network is a 5G network. In addition, for example, the second wireless network is a 6G network. Moreover, for example, the first information includes a first quality of the 5G network below a first predetermined threshold. Furthermore, for example, the second information includes a second quality of the 6G network above a second predetermined threshold. Furthermore, for example, the second type of RRM measurement satisfying the condition includes analyzing the first information and the second information. Additionally, for example, a frequency of the first type of RRM measurement are reduced based at least in part on the priority. Still further, for example, the handover configuration includes a first mobility procedure using the first type of RRM measurement associated with the first RAT. Even further, for example, the first mobility procedure is associated with at least one of: reporting of an event, a measurement, or a condition associated with lower layer triggered mobility (LTM), or an evaluation of a conditional handover (CHO). Yet further, for example, the method 700 includes canceling the first mobility procedure. For example, the method 700 includes increasing the second type of RRM measurement. Also, for example, the increasing of the second type of RRM measurement includes at least one of: increasing a frequency of the second type of RRM measurement, initiating measurement of an additional carrier, or initiating measurement of an additional beam. Further, for example, the method 700 includes initiating the second mobility procedure. In addition, for example, the second mobility procedure is associated with at least one of: inter-RAT lower layer triggered mobility (LTM), or inter-RAT synchronization. Moreover, for example, each of the first type of RRM measurement and the second type of RRM measurement is associated with lower layer triggered mobility (LTM). Furthermore, for example, the method 700 includes: performing a measurement report based at least in part on: detecting 6G standalone coverage; and determining the second wireless network is ready for handover. Additionally, for example, the method 700 includes receiving, via the second RAT, from the first wireless network, first information including the handover configuration including information for one or more lower layer triggered mobility (LTM) candidates via the second RAT. Still further, for example, the method 700 includes performing one or more handover preparation steps using the second RAT while connected via the first RAT. Even further, for example, the method 700 includes receiving an LTM indication from the first wireless network to initiate reconfiguration to the second wireless network using the second RAT. Yet further, for example, the method 700 includes performing a handover from the first wireless network to the second wireless network. For example, the method includes transmitting a handover complete indication to the second wireless network using the handover configuration received from the first wireless network.

In certain representative embodiments, a method 800, performed by a wireless transmit and/or receive unit (WTRU), is provided for configuring inter-Radio Access Technology (RAT) mobility prioritization associated with a first RAT of a first wireless network and a second RAT of a second wireless network. For example, the method 800 includes measuring 810, via the first RAT, at the first wireless network, first information regarding one or more first conditions associated with at least one of the first RAT or the first wireless network serving the first RAT. Also, for example, the method 800 includes measuring 820, via the second RAT, at the second wireless network, second information regarding one or more second conditions associated with at least one of the second RAT or the second wireless network serving the second RAT. Further, for example, the method 800 includes receiving 830, via the first RAT, from the first wireless network, an indication of a priority of the first RAT relative to the second RAT based at least in part on the first information and the second information. In addition, for example, the method 800 includes performing 840 at least one first mobility procedure associated with the first RAT based at least in part on the priority of the first RAT being greater than the priority of the second RAT. Moreover, for example, the method 800 includes performing 850 at least one second mobility procedure associated with the second RAT based at least in part on the priority of the second RAT being greater than the priority of the first RAT. Furthermore, for example, the priority is determined at the first wireless network. Additionally, for example, the performing 840 the at least one first mobility procedure associated with the first RAT includes: applying a measurement configuration associated with the first mobility procedure via the first RAT. Still further, for example, the first wireless network is a 5G network. Even further, for example, the second wireless network is a 6G network. Yet further, for example, the first information includes a first quality of the 5G network below a first predetermined threshold. For example, the second information includes a second quality of the 6G network above a second predetermined threshold. Also, for example, the first mobility procedure includes identifying at least one of: one or more candidate cells to measure, or a periodicity of measurements according to the measurement configuration. Further, for example, the performing 850 the at least one second mobility procedure associated with the second RAT includes: activating or deactivating the at least one second mobility procedure associated with the second RAT. In addition, for example, the at least one second mobility procedure associated with the second RAT is associated with at least one of: lower layer triggered mobility (LTM), or a conditional handover (CHO). Moreover, for example, the method 800 further includes performing higher priority measurements via the second RAT. Furthermore, for example, the WTRU is to reduce a frequency of power saving inter-RAT measurements via the second RAT. Additionally, for example, during a time period in which a measurement of a serving cell of the second wireless network is above a threshold for enabling measurements, the WTRU is to: cancel any ongoing mobility procedure associated with the first RAT; and initiate higher priority mobility towards the second wireless network via the second RAT.

In certain representative embodiments, a WTRU is configured for inter-RAT mobility prioritization between a first RAT of a first wireless network and a second RAT of a second wireless network. For example, the WTRU includes a processer; and a transceiver coupled to the processer. Also, for example, the WTRU is to measure, via the first RAT, at the first wireless network, first information regarding one or more first conditions associated with at least one of the first RAT or the first wireless network serving the first RAT. Further, for example, the WTRU is to measure, via the second RAT, at the second wireless network, second information regarding one or more second conditions associated with at least one of the second RAT or the second wireless network serving the second RAT. In addition, for example, for example, the WTRU is to receive, via the first RAT, from the first wireless network, an indication of a priority of the first RAT relative to the second RAT based at least in part on the first information and the second information. Moreover, for example, the WTRU is to perform at least one first mobility procedure associated with the first RAT based at least in part on the priority of the first RAT being greater than the priority of the second RAT. Furthermore, for example, the WTRU is to perform at least one second mobility procedure associated with the second RAT based at least in part on the priority of the second RAT being greater than the priority of the first RAT.

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

Each of the contents of the following references is incorporated by reference herein in their entireties: (1) 3GPP, RP-234036: New Work Item Description: “NR Mobility Enhancements Phase 4,” 3GPP TSG RAN Meeting #102, December 2023; and (2) 3GPP TS 38.300 v18.0.0, “Technical Specification Group Radio Access Network; NR; NR and NG-RAN Overall Description; Stage 2 (Release 18),” including Section 9.2.3.5, “L1/L2-Triggered Mobility,” December 2023.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6, 35 U.S.C. § 112(f) or means-plus-function claim format, and any claim without the terms “means for” is not so intended.

What is claimed:

1. A method, performed via a first Radio Access Technology (RAT) of a first wireless network, for configuring inter-RAT mobility prioritization associated with the first RAT of the first wireless network and a second RAT of a second wireless network, the method comprising:
receiving, via the second RAT, from the first wireless network, first information comprising a handover configuration and an indication of a priority of the second RAT;
performing, via the first RAT, a first type of Radio Resource Management (RRM) measurement;
based at least in part on the priority, performing, via the second RAT, a second type of RRM measurement; and
based at least in part on the RRM measurement of the second RAT satisfying a condition:
updating the first type of RRM measurement and the second type of RRM measurement to a third type of RRM measurement and a fourth type of RRM measurement, respectively; and
initiating a handover procedure to the second wireless network.

2. The method of claim 1, wherein the priority is determined at the first wireless network.

3. The method of claim 1, wherein:
the indication of the priority comprises information indicating at least one of:
all 6G carriers,
standalone 6G carriers, or
a combination of carriers; and
the handover configuration comprises:
a first mobility procedure using the first type of RRM measurement associated with the first RAT;
a second mobility procedure using a second type of RRM measurement associated with the second RAT;
the indication of the priority of the second RAT; and
a condition for determining how to perform the second type of RRM measurement.

4. The method of claim 1, wherein the second type of RRM measurement satisfying the condition comprises comparing a standalone 6G carrier measurement to a threshold.

5. The method of claim 1, wherein:
the first wireless network is a 5G network;
the second wireless network is a 6G network;
the first information comprises a first quality of the 5G network below a first predetermined threshold;
second information comprises a second quality of the 6G network above a second predetermined threshold; and
the second type of RRM measurement satisfying the condition comprises analyzing the first information and the second information.

6. The method of claim 1, wherein a frequency of the first type of RRM measurement are reduced based at least in part on the priority.

7. The method of claim 1, wherein:
the handover configuration comprises a first mobility procedure using the first type of RRM measurement associated with the first RAT;
the first mobility procedure is associated with at least one of:
reporting of an event, a measurement, or a condition associated with lower layer triggered mobility (LTM), or
an evaluation of a conditional handover (CHO) condition; and
the method comprises canceling the first mobility procedure.

8. The method of claim 1, comprising:
increasing a frequency of the second type of RRM measurement,
wherein the increasing of the second type of RRM measurement comprises at least one of:
increasing a frequency of the second type of RRM measurement,
initiating measurement of an additional carrier, or
initiating measurement of an additional beam.

9. The method of claim 1, comprising:
initiating the second mobility procedure,
wherein the second mobility procedure is associated with at least one of:
inter-RAT lower layer triggered mobility (LTM), or
inter-RAT synchronization.

10. The method of claim 1, wherein:
each of the first type of RRM measurement and the second type of RRM measurement is associated with lower layer triggered mobility (LTM); and
the method comprises:
performing a measurement report based at least in part on:
detecting 6G standalone coverage; and
determining the second wireless network is ready for handover.

11. The method of claim 1, comprising:
receiving, via the second RAT, from the first wireless network, first information comprising the handover configuration comprising information for one or more lower layer triggered mobility (LTM) candidates via the second RAT;
performing one or more handover preparation steps using the second RAT while connected via the first RAT;
receiving an LTM indication from the first wireless network to initiate reconfiguration to the second wireless network using the second RAT;
performing a handover from the first wireless network to the second wireless network; and
transmitting a handover complete indication to the second wireless network using the handover configuration received from the first wireless network.

12. A method, performed by a wireless transmit and/or receive unit (WTRU), for configuring inter-Radio Access Technology (RAT) mobility prioritization associated with a first RAT of a first wireless network and a second RAT of a second wireless network, the method comprising:
measuring, via the first RAT, at the first wireless network, first information regarding one or more first conditions associated with at least one of the first RAT or the first wireless network serving the first RAT;
measuring, via the second RAT, at the second wireless network, second information regarding one or more second conditions associated with at least one of the second RAT or the second wireless network serving the second RAT;
receiving, via the first RAT, from the first wireless network, an indication of a priority of the first RAT relative to the second RAT based at least in part on the first information and the second information; and
performing at least one first mobility procedure associated with the first RAT based at least in part on the priority of the first RAT being greater than the priority of the second RAT; or
performing at least one second mobility procedure associated with the second RAT based at least in part on the priority of the second RAT being greater than the priority of the first RAT.

13. The method of claim 12, wherein the priority is determined at the first wireless network.

14. The method of claim 12, wherein the performing the at least one first mobility procedure associated with the first RAT comprises:
applying a measurement configuration associated with the first mobility procedure via the first RAT.

15. The method of claim 14, wherein:
the first wireless network is a 5G network;
the second wireless network is a 6G network;
the first information comprises a first quality of the 5G network below a first predetermined threshold;
the second information comprises a second quality of the 6G network above a second predetermined threshold; and
the first mobility procedure comprises identifying at least one of:
one or more candidate cells to measure, or
a periodicity of measurements according to the measurement configuration.

16. The method of claim 12, wherein the performing the at least one second mobility procedure associated with the second RAT comprises:
activating or deactivating the at least one second mobility procedure associated with the second RAT.

17. The method of claim 16, wherein:
the first wireless network is a 5G network;
the second wireless network is a 6G network; and
the at least one second mobility procedure associated with the second RAT is associated with at least one of:
lower layer triggered mobility (LTM), or
a conditional handover (CHO);
the method further comprising:
performing higher priority measurements via the second RAT.

18. The method of claim 12, wherein the WTRU is to reduce a frequency of power saving inter-RAT measurements via the second RAT.

19. The method of claim 18, wherein, during a time period in which a measurement of a serving cell of the second wireless network is above a threshold for enabling measurements, the WTRU is to:
cancel any ongoing mobility procedure associated with the first RAT; and
initiate higher priority mobility towards the second wireless network via the second RAT.

20. A wireless transmit and/or receive unit (WTRU) configured for inter-Radio Access Technology (RAT) mobility prioritization between a first RAT of a first wireless network and a second RAT of a second wireless network, the WTRU comprising:
a processer; and
a transceiver coupled to the processer, wherein the WTRU is to:
measure, via the first RAT, at the first wireless network, first information regarding one or more first conditions associated with at least one of the first RAT or the first wireless network serving the first RAT;
measure, via the second RAT, at the second wireless network, second information regarding one or more second conditions associated with at least one of the second RAT or the second wireless network serving the second RAT;
receive, via the first RAT, from the first wireless network, an indication of a priority of the first RAT relative to the second RAT based at least in part on the first information and the second information; and
perform at least one first mobility procedure associated with the first RAT based at least in part on the priority of the first RAT being greater than the priority of the second RAT: or
perform at least one second mobility procedure associated with the second RAT based at least in part on the priority of the second RAT being greater than the priority of the first RAT.
